(19) United States
(12) Patent Application Publication
(10) Pub. No.: US 2006/0059256 A1
(43) Pub. Date: Mar. 16, 2006

(54) Signaling a state of a transmission link via a transport control protocol

(75) Inventor: Naveen K. Kakani, Irving, TX (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/938,427

(22) Filed: Sep. 10, 2004

(51) Int. Cl. G06F 15/173

(52) U.S. Cl. 709/224

(57) ABSTRACT

A method, a system, a sender, a receiver, a device and software applications are shown for transferring data segments, wherein data segments are sent from a sender to a receiver, wherein said sender receives acknowledgements from said receiver, and wherein said acknowledgements acknowledge reception of said sent data segments at said receiver and contain information on whether at least one transmission link within a data network between said sender and receiver undergoes bad transmission conditions. In an embodiment of the invention, timers associated with each of said sent data segments, respectively, are started, and it is decided if it is possible to prolong timers that have expired before acknowledgements of data segments associated with said timers are received at least in partial dependence on said information whether at least one transmission link within a data network between said sender and receiver undergoes bad transmission conditions.

### FIELD OF THE INVENTION

This invention relates to a method, a system, a sender, a receiver, a device and software applications for transferring data segments from a sender to a receiver.

### BACKGROUND OF THE INVENTION

The Transport Control Protocol (TCP) is a transport-layer, connection-oriented and reliable transport protocol that provides for full duplex data transfer between two hosts. In the detailed description of this specification, without loss of generality, only one transmission direction will be considered, so that it is natural to speak of a sender and a receiver in said one-way transmission. It is readily understood that with a change of the transmission direction, the roles of sender and receiver are interchanged.

An application-layer data stream that is to be transmitted via the TCP is first directed into the sender's send buffer, which is established during the establishment of a TCP connection between the sender and the receiver. TCP then extracts portions of said data stream from said send buffer, and furnishes them with TCP headers to obtain TCP segments. These TCP segments are exchanged between peer TCP entities in the sender and receiver. For the actual transfer of these TCP segments, the segments are passed down to the network layer (e.g. the Internet Protocol (IP) layer), where they are separately encapsulated within network-layer datagrams. The network-layer datagrams are then sent into the network. When the TCP entity at the receiver receives a TCP segment, the segment's payload is placed into a receive buffer, from which an application may now portion-wise read out the transferred application-layer data stream.

Because the TCP runs only in the sender and receiver and not in the intermediate network elements (e.g. routers and bridges), the intermediate network elements do not maintain TCP connection state. In fact, the intermediate network elements are completely oblivious to TCP; they see only datagrams, not TCP connections.

Referring to FIG. 5, a prior art TCP segment 500 consists of a TCP header 501 . . . 516 and a payload (or data) field 517, wherein the data field 517 contains a portion of said application-layer data stream. The structure depicted in FIG. 5 includes the header field with Source 501 and Destination 502 Port Numbers, that are used for multiplexing/demultiplexing data from/to upper layer applications. The header also includes a checksum field 514. The 32-bit sequence number field 503 and 32-bit acknowledgement number field 504 are used by the TCP sender and receiver in implementing a reliable data transfer service, as will be discussed below. The 16-bit receiver window size 513 is used for the purpose of flow control by indicating the number of bytes a receiver is willing to accept. The 4-bit header length field 505 specifies the length of the TCP header in 32 bit words, as the TCP header can be of variable length due to the TCP options field 516 (typically, the options field 516 is empty, so that the length of the typical TCP header is 20 bytes). The flag field 507 . . . 512 contains 6 bits. Therein, the ACK bit 508 is used to indicate that the value carried in the acknowledgement field 504 is valid. The RST 510, SYN 511 and FIN 512 bits are used for connection setup and teardown. When the PSH 509 bit is set, this is an indication that the receiver should pass the data to the upper layer immediately. The URG 507 bit is used to indicate that there is data in this segment that the sending-site upper layer has marked as urgent, and the location of the last byte of this data is indicated by the 16-bit urgent data pointer 515. Finally, there exist 6 unused bits in field 506.

TCP views data as an unstructured, but ordered, stream of bytes (or octets). TCP's use of sequence numbers reflects this view in that sequence numbers are taken over the stream of transmitted bytes and not over the series of transmitted segments. The sequence number for a segment (as contained in the TCP header field 503) is thus the byte-stream number of the first byte in the segment.

Data segments that were received at the receiver are acknowledged by means of the acknowledgement number 504 in the TCP header. Therein, the convention is used that the acknowledgement number a receiver puts into a TCP header is the sequence number of the next byte it is expecting from the sender. The presence of an acknowledgement number 504 in the TCP header is indicated by setting the ACK bit 508 in the TCP header. A receiver may send acknowledgements either piggy-backed to data, i.e. received TCP segments are acknowledged with a complete TCP segment with the ACK bit 508 set and the acknowledgement number 504 indicating the next expected byte, or without data, i.e. received TCP segments are acknowledged with a TCP segment with the ACK bit 508 set and the acknowledgement number 504 indicating the next expected byte, but without a data field 517.

TCP provides reliable data transfer by using positive acknowledgements and timers. TCP acknowledges data that has been received correctly, and retransmits segments when segments or their corresponding acknowledgements are thought to be lost or corrupted. In particular, for each TCP segment the sender sends into a TCP connection, a timer is started. The value of said timer may for instance be set to a Retransmission Time-Out (RTO). If this segment-specific timer expires before the sender receives an acknowledgement for the data in the segment, it retransmits the segment.

TCP also uses pipelining, allowing the sender to have multiple transmitted but yet-to-be acknowledged segments outstanding at any given time. The specific number of outstanding unacknowledged segments that a sender can have is determined by TCP's flow control and congestion control mechanisms.

Flow control is provided to eliminate the possibility of the sender sending too much data too quickly, thus overflowing the receive buffer, which is not emptied fast enough by an application reading from said receive buffer. Flow control is implemented by having the sender maintain a variable called the receive window. The receive window is used to give the sender an impression about how much free buffer space is available at the receiver. The receive window, together with the amount TCP data stored in the receive buffer, yields the overall receive buffer size. The receive window is signalled to the sender by means of the receive window field 513 of the TCP header (see FIG. 5). The sender is then not allowed to transmit more TCP segments than fit into this signalled receive window.

A TCP connection can not only be limited through the size of the receive buffer, but also due to congestion in the network between the sender and the receiver. The adaptation of the speed at which the sender injects TCP segments into the network towards the receiver is controlled by congestion control, which comprises the four algorithms slow start, congestion avoidance, fast retransmit and fast recovery, as discussed in Request for Comments (RFC) document 2001 “TCP Slow Start, Congestion Avoidance, Fast Retransmit, and Fast Recovery Algorithms” by W. Stevens, January 1997. In the following description, only slow start and congestion avoidance will be discussed in more detail.

Slow start operates by observing that the rate at which new segments should be injected into the network is the rate at which the acknowledgements are returned by the receiver. Slow start thus adds another window to the sender's TCP: the congestion window, called “cwnd”. When a new connection is established, the congestion window is initialized to one segment. Each time an acknowledgement is received, the congestion window is increased by one segment. The sender can transmit up to the minimum of the congestion window and the receive window as signalled by the receiver (also denoted as advertised window). The congestion window is thus controlled by the sender, while the receive window is controlled by the receiver. The former is based on the sender's assessment of perceived network congestion; the latter is related to the amount of available buffer space at the receiver for this connection. In slow start, the sender starts by transmitting one segment and waiting for its acknowledgement. When that acknowledgement is received, the congestion window is incremented from one to two, and two segments can be sent. When each of those two segments is acknowledged, the congestion window is increased to four. This provides an exponential growth, although it is not exactly exponential because the receiver may delay its acknowledgements, typically sending one acknowledgement for every two segments that it receives.

At some point the capacity of the network between the sender and the receiver can be reached, and an intermediate router will start discarding packets. This tells the sender that its congestion window has got too large.

Congestion can occur when data arrives on a big pipe (a fast LAN) and gets sent out a smaller pipe (a slower WAN). Congestion can also occur when multiple input streams arrive at a router the output capacity of which is less than the sum of the inputs. Congestion avoidance, the second algorithm of TCP's congestion control, is a way to deal with lost packets.

The assumption of the congestion avoidance algorithm is that segment loss caused by damage is very small (much less than 1%), therefore the loss of a segment signals congestion somewhere in the network between the source and destination. There are two indications of segment loss: a timeout occurring and the receipt of duplicate acknowledgements. Congestion avoidance and slow start are basically independent algorithms with different objectives. But when congestion occurs, TCP must slow down its transmission rate of packets into the network, and then invoke slow start to get things going again. In practice they are thus implemented together.

Congestion avoidance and slow start require that two variables be maintained for each connection: a congestion window, cwnd, and a slow start threshold size, ssthresh.

The combined algorithm operates as follows:
Initialization for a given connection sets cwnd to one segment and ssthresh to 65535 bytes.
The TCP sender never sends more than the minimum of cwnd and the receive window.
When congestion occurs (indicated by a timeout or the reception of duplicate acknowledgements), one-half of the current window size (the minimum of cwnd and the receive window, but at least two segments) is saved in ssthresh. Additionally, if the congestion is indicated by a timeout, cwnd is set to one segment (i.e., slow start).
When new data is acknowledged by the receiver, increase cwnd, but the way it increases depends on whether TCP is performing slow start or congestion avoidance.

If cwnd is less than or equal to ssthresh, TCP is in slow start; otherwise TCP is performing congestion avoidance. Slow start continues until TCP is halfway to where it was when congestion occurred (since it recorded half of the window size that caused the problem in the second step), and then congestion avoidance takes over. Slow start has cwnd begin at one segment, and be incremented by one segment every time an acknowledgement is received. As mentioned earlier, this opens the window exponentially: send one segment, then two, then four, and so on. Congestion avoidance dictates that cwnd be incremented by segsize*segsize/cwnd each time an acknowledgement is received, where segsize is the segment size and cwnd is maintained in bytes. This is a linear growth of cwnd, compared to slow start's exponential growth. The increase in cwnd should be at most one segment each Round-Trip Time (RTT) (regardless how many acknowledgements are received in that RTT), whereas slow start increments cwnd by the number of acknowledgements received in a round-trip time.

TCP's congestion control was designed for wired networks, wherein, due to the high transmission quality of wired transmission links, assumed loss of data segments, which is indicated by expiring timers, can be almost entirely accounted to congestion in the network. After each assumed loss of a TCP segment, congestion control thus initiates the slow start algorithm, which sets the congestion window (and thus the number of segments that can be sent by the sender) to one segment and only slowly increases the segment window after the reception of acknowledgements.

However, if the network between the sender and the receiver also comprises wireless transmission links, expiration of timers and resulting assumed loss of data segments is frequently due to a bad transmission quality of said wireless links, causing increased transmission times for the data segments, and not to congestion in the network. Moving to the slow start procedure after each assumed data segment loss in such a system in order to reduce the traffic and thus to resolve the erroneously assumed congestion does not contribute to increasing the transmission quality of said link and in contrast, only reduces the throughput of the connection.

To allow for a fast recovery from an assumed segment loss in an Internet connection, in which a wireless link exists, U.S. 2003/0103452 A1, filed by the applicant, proposes to accelerate the slow start procedure in case of a bad transmission link by increasing the congestion window by k segments per received acknowledgement, where k is larger than one. However, this approach still suffers from a significant collapse in throughput, as the slow start procedure still has to start with a much reduced congestion window size.

### SUMMARY OF THE INVENTION

In view of the above-mentioned problems, the present invention thus proposes an improved method, system, sender, receiver, device and software applications for transferring data segments between a sender and a receiver.

It is proposed a method for transferring data segments between a sender and a receiver, comprising sending one or more data segments from said sender to said receiver, and receiving one or more acknowledgements from said receiver, wherein said acknowledgements acknowledge reception of said sent data segments at said receiver and contain information on whether at least one transmission link within a data network between said sender and receiver undergoes bad transmission conditions.

Said sender and receiver may represent nodes in a network, between which data segments are transferred. Said network may be composed of a plurality of nodes, an said nodes may be connected by wired and wireless links. Said network may for instance comprise a radio access network of a wireless communication system and an internet, so that transfer of data segments between a wireless terminal of said wireless communication system and a server in said internet is possible. Said data segments may be transferred between said sender and receiver in a full-duplex connection, so that in one transmission direction, said sender acts as a sender and said receiver as a receiver, whereas in the other transmission direction, said sender acts as a receiver and said receiver acts as a sender. There may be several senders and several receivers, and said transfer of said data segments may be unicast, multicast or broadcast.

Said data segments represent structured containers for data, which may for instance be information-carrying symbols such as bits. Said data may for instance stem from a data stream that is produced by an application layer, for instance a multimedia stream or a file. Said data stream then may be segmented into said data segments, wherein the format of said data segments may be prescribed by a protocol, for instance the Transport Control Protocol (TCP), in which case said data segments are TCP segments. Said data segments then may be transmitted between peer protocol entities of said sender and receiver, wherein the services of lower-layer protocols, for instance of a network-layer protocol, may be utilized for the actual transfer of the data segments. Each data segment may be composed of a header and a payload section.

Said acknowledgements are transmitted by said receiver upon reception of data segments, either with a raw acknowledgement, i.e. a data segment without payload, or with a piggy-backed acknowledgement that is contained in a data segment transmitted from said receiver to said sender. Said acknowledgement may for instance contain an ACK bit and an acknowledgement number, wherein, if said ACK bit is set, said acknowledgement number acknowledges received data segments implicitly by stating which data segment or byte position in the data stream said data segments stem from are expected by said receiver next. According to the present invention, said acknowledgements contain information on whether at least one transmission link within a data network between said sender and receiver undergoes bad transmission conditions. This information allows the sender to at least partially adapt the amount and/or frequency of data segment transmissions to the state of the data network. For instance, if said sender operates timers for each sent data segment, and re-transmits data segments if the timers expire before acknowledgements of the data segments have been received, the sender may prolong said timers if it is informed that the at least one transmission link within said data network undergoes bad transmission conditions. The rationale behind this approach is the fact that said wireless transmission link undergoing bad transmission conditions then only increases the delay of the data segments, so that their corresponding timers expire, but does not cause congestion, so that data segment re-transmission is actually not required.

Said information may be made available to said receiver for instance via a link monitor that may interact with lower layer protocols, for instance MAC/RLC and/or SNDCP/LLC protocols in case of an EGPRS system, at either side of the transmission link, and said receiver then may use the acknowledgements to signal this information to the sender. For instance, an unused bit in said acknowledgements may be exploited as a bad transmission link flag. Therein, it may not necessarily be required that the sender is informed which transmission link undergoes bad transmission conditions, only the fact that one link along the transmission path of the data segments undergoes bad transmission conditions may be sufficient for the sender to adapt his sending of data segments.

The method of an embodiment of the present invention further comprises starting timers associated with each of said sent data segments, respectively, and deciding if it is possible to prolong at least one of said timers that has expired before an acknowledgement of a data segment associated with said timer is received, wherein said decision at least partially depends on information whether at least one transmission link within a data network between said sender and receiver undergoes bad transmission conditions.

The number of data segments said sender is allowed to send may be limited by a maximum value, which may be determined dynamically based on a state of a buffer in said receiver and on an estimated congestion state of the network. Said sender starts a timer for each of said sent data segments in order to control the time duration from the start of the sending of a segment and the reception of an acknowledgement for said segment. Said timers may be set to a pre-defined or dynamically determined value, for instance a Retransmission Time-Out (RTO), and it may be prescribed that if said timer expires before an acknowledgement of a sent data segment is received from said receiver, said data segment is considered lost by said sender and is re-transmitted. Said re-transmission may be accompanied by a reduction of the number of data segments said sender is allowed to send without having received an acknowledgement yet, for instance, in case of TCP, said re-transmission may cause said sender to initiate a slow start procedure.

In this embodiment of the present invention, if one of said timers with a certain elapsing time has expired before an acknowledgement of the data segment said timer is associated with has been received, the sanctions related to the expiration of a timer do not have to be immediately applied as it is the case in prior art. In fact, according to this embodiment of the present invention, it is first checked if a prolonging of said expired timer is possible. Such a prolonging may be implemented by adding some extra time to said pre-defined or dynamically adjusted elapsing time of said timer. Said decision may be triggered by the expiration of said timer, and at least partially depends on information whether at least one transmission link within a data network between said sender and receiver undergoes bad transmission conditions. For instance, said prolonging may only be possible if a transmission link in said network between said sender and receiver undergoes bad transmission conditions, and the degrees of freedom in prolonging said timer may be limited by a maximum value, which may also be dynamically changed. Said information whether at least one transmission link within a data network between said sender and receiver undergoes bad transmission conditions may for instance be stored in said sender by setting a sender bad transmission link flag, so that, when a timer expirers before an according acknowledgement is received, it may be decided in at least partial dependence on said information stored in said flag if said timer can be prolonged or not.

Thus in contrast to prior art, this embodiment of the present invention proposes to include the option of prolonging timers into a method for transferring data segments between a sender and a receiver, and thus allows for a much more flexible and improved implementation of said transfer.

According to the method of a further embodiment of the present invention, it is only possible to prolong said expired timer if a first condition, that at least one transmission link within a data network between said sender and said receiver undergoes bad transmission conditions, and a second condition, that said expired timer, after prolonging, will not exceed a maximum value for said timer, are both true. The pre-defined or dynamically adjusted elapsing time for said timers may be optomized or determined under the assumption that networks are only composed of high-quality transmission links that do not undergo bad transmission conditions, as for instance high delay, or high noise and/or interference power and correspondingly small bit error or packet error rates. If, however, a transmission link is contained in said network that eventually undergoes such bad transmission conditions, said elapsing times may no longer be appropriate, and, according to the present invention, it may be advantageous to prolong this elapsing time of a timer if said timer expires. For instance, in a TCP, an RTO timer may be dynamically adjusted depending on an average Round Trip Time (RTT) of data segments. If such an RTO timer expires, it is assumed that the associated data segment is lost, which, under the assumption of a completely wire-bound network, is accounted to congestion in the network, and is combated by retransmitting the data segment and moving to slow start. However, if said network comprises for instance at least one wireless transmission link, delay of a data segment may also be caused by bad transmission conditions on said link, and re-transmitting said data segment and moving to slow start as in prior art may only increase overhead and decrease the throughput without having any further effect on the probability that the re-transmitted data segment will be transmitted more rapidly. It is thus advisable to prolong the expired timer in that case to avoid both the re-transmission of the data segment and the slow start procedure and give said data segment a chance to be acknowledged in time. This prolongation may take place several times for the same timer, as long as a maximum value for said timer is not exceeded. This maximum value may be a pre-defined value or may be determined dynamically under consideration of the state of the network or other parameters.

The method of a further embodiment of the present invention further comprises prolonging said expired timer if it is decided that prolonging of said expired timer is possible; and reducing the size of a congestion window, which at least partially determines the number of data segments said sender is allowed to send, if it is decided that prolonging of said expired timer is not possible.

Said expired timer may for instance be prolonged by adding a pre-defined or dynamically determined time period to its value, or by multiplying its value with a pre-defined or dynamically adjusted factor. If it is decided that prolonging of said timer is not possible, the size of said congestion window is reduced, for instance it may be set to the size of one data segment. Said congestion window may, together with a receive window that indicates how many data segments can still be stored in a receive buffer, determine how many data segments said sender is allowed to send, for instance, the number of data segments said sender is allowed to send may be the minimum value of both the size of the congestion window and the size of the receive window. In addition to said reduction of said congestion window, said data segment may also be re-transmitted, if it is decided that prolonging is not possible.

According to the method of a further embodiment of the present invention, said transmission link may be a wireless link. This may for instance be a wireless link of a radio communication system, a wireless local area network or a satellite-based network.

According to the method of a further embodiment of the present invention, said expired timer may be prolonged by doubling its value. This allows for an extremely simple implementation. Also other multiplication factors may be possible.

According to the method of a further embodiment of the present invention, said maximum value for said timer may depend on the quotient of a size of a buffer at one end of said transmission link and an expected bandwidth of said transmission link.

According to the method of a further embodiment of the present invention, said transmission link may be a wireless link between a mobile terminal and a node of said network, wherein said buffer is a buffer in said node, and wherein said buffer is related to said mobile terminal. Said node may be for instance a radio access network of a radio communications system. Said buffer may for instance be a mobile terminal specific buffer in said radio access network.

According to the method of a further embodiment of the present invention, said bandwidth may depend on a timeslot capability of said mobile terminal, a highest reliable coding scheme that can be used on said transmission link and an average error rate on said transmission link. Said timeslot capability may for instance indicate how many timeslots a mobile terminal can concurrently use. Said highest reliable coding scheme may be the coding scheme with the largest amount of redundancy. In an EGPRS system, said coding scheme may for instance be the CS2 coding scheme. Said average error rate may for instance be an average block error rate.

According to the method of a further embodiment of the present invention, said bandwidth BW may be determined as

$$BW = \frac{TC \times r}{1 - e} ,$$

wherein TC is said timeslot capability of said mobile terminal, r is a data rate of said highest reliable coding scheme and e is an average block error rate on said transmission link.

According to the method of a further embodiment of the present invention, said information on whether at least one transmission link within said data network between said sender and receiver undergoes bad transmission conditions is represented by a Bad Transmission Link Flag, BTLF, in said acknowledgements. Said flag may for instance be represented by one or several bits and may be set or reset to indicate that at least one transmission link in said data network undergoes bad transmission conditions or not, respectively.

According to the method of a further embodiment of the present invention said sender, upon receiving an acknowledgement from said receiver, performs the following: if said acknowledgement has a BTLF set and if said acknowledgement does not indicate a mis-ordering of data segments at said receiver, setting a Sender Bad Transmission Link Flag, SBTLF, and starting a timer T_{bad,s}; and if said acknowledgement has a BTLF reset and if said SBTLF is not set, resetting said SBTLF. Said timer T_{bad,s} may for instance be initialised to the value of an RTO timer.

According to the method of a further embodiment of the present invention said sender, when said timer T_{bad,s} expires, performs the following: resetting said SBTLF.

According to the method of a further embodiment of the present invention said sender, when one of said timers expires, performs the following: prolonging said expired timer, if said SBTLF is set and if said expired timer, after prolonging, will not exceed said maximum value for said timer; reducing the size of said congestion window, if said SBTLF is set and if said expired timer, after prolonging, will exceed said maximum value for said timer; and shortening said expired timer and reducing the size of said congestion window, if said SBTLF is not set.

According to the method of a further embodiment of the present invention, said expired timer is not prolonged if it is indicated to at least one of said sender and said receiver that at least one data packet was lost on said transmission link. If an actual data packet loss on said transmission link occurs, allowing said expired timer to be prolonged may be sub-optimum, and it may be more advantageous to allow for a fast re-transmission of the corresponding data segment.

According to the method of a further embodiment of the present invention, said transferring of data segments between said sender and said receiver is controlled by the Transport Control Protocol.

According to the method of a further embodiment of the present invention, said transferring of data segments between said sender and said receiver is controlled by the Transport Control Protocol, and with said reducing of said size of said congestion window, a slow start procedure is started.

According to the method of a further embodiment of the present invention, said transferring of data segments between said sender and said receiver is controlled by the Transport Control Protocol, and said expired timer is a Retransmission Time-Out, RTO, timer.

According to the method of a further embodiment of the present invention, said transferring of data segments between said sender and said receiver is controlled by the Transport Control Protocol, TCP, said acknowledgements are TCP acknowledgements, and at least one bit in said TCP acknowledgements is used to set and reset said bad transmission link flag.

It is further proposed a method for transferring data segments between a sender and a receiver, comprising receiving one or more data segments sent from said sender to said receiver, and sending one or more acknowledgements to said sender, wherein said acknowledgements acknowledge reception of said sent data segments at said receiver and contain information on whether at least one transmission link within a data network between said sender and receiver undergoes bad transmission conditions. Said information may be made available to said receiver by a link monitor instance, which may monitor the transmission performance of a transmission link on lower protocol levels such as the physical layer, the Medium Access Control (MAC)/Radio Link Control (RLC) layer and/or the Sub-Network Dependent Convergence Protocol (SNDCP)/Logical Link Control (LLC) layer. Said sender then is furnished with said information via the acknowledgements that are sent from said receiver, for instance by means of a bad transmission link flag in said acknowledgements. Based on said information, said sender then may adapt the amount and/or frequency of his sending of data segments to the state of the data network, which results in an improved performance of the data segment transfer.

The method of an embodiment of the present invention further comprises receiving a bad transmission link message from a link monitor that indicates that at least one transmission link within said data network undergoes bad transmission conditions. Said link monitor may for instance comprise means for measuring or estimating a transmission quality of said transmission link and to decide if said transmission link has to be considered bad or good. Said link monitor may measure or estimate said transmission quality on both sides of said transmission link or on only one side of said transmission link.

According to the method of a further embodiment of the present invention, said information on whether at least one transmission link within said data network between said sender and receiver undergoes bad transmission conditions is represented by a Bad Transmission Link Flag, BTLF, in said acknowledgements. Said BTLF may be set or reset by said receiver to indicate that said transmission link undergoes bad transmission conditions and thus prolonging of expired timers may be appropriate.

According to the method of a further embodiment of the present invention, said receiver maintains a Receiver Bad Transmission Link Flag, RBTLF, determining if acknowledgements are sent with said BTLF set or reset, and wherein said receiver, upon receiving said bad transmission link message, performs the following starting a timer T_{bad,r} and setting said RBTLF; sending an acknowledgement of a newly received data segment with said BTLF set, if acknowledgement of said newly received data segment is possible; sending an acknowledgement of a previously received data segment with said BTLF set, if acknowledgement of a newly received data segment is not possible, but acknowledgement of said previously received data segment is possible; if a further bad transmission link message is received from said link monitor before the expiry of said timer T_{bad,r}, a) starting said timer T_{bad,r} again, b) sending an acknowledgement of a newly received data segment with said BTLF set, if acknowledgement of said newly received data segment is possible, and c) sending an acknowledgement of a previously received data segment with said BTLF set, if acknowledgement of a newly received data segment is not possible, but acknowledgement of said previously received data segment is possible; and resetting said RBTLF, if no further bad transmission link message is received from said link monitor before the expiry of said timer T_{bad,r}. Therein, said sending of an acknowledgement of a newly received data segment with said BTLF set, if acknowledgement of said newly received data segment is possible is also performed if said newly received data segment indicates a mis-ordering of data segments at said receiver.

According to the method of a further embodiment of the present invention, a value of said timer T_{bad,r} equals a value of a timer monitored at said receiver. Said time may for instance be an RTO timer.

It is further proposed a system for transferring data segments, comprising: a sender, and a receiver; wherein said sender comprises means arranged for sending one or more data segments from said sender to said receiver and means arranged for receiving one or more acknowledgements from said receiver, wherein said receiver comprises means arranged for receiving said sent data segments, and means arranged for sending said acknowledgements, and wherein said acknowledgements acknowledge reception of said sent data segments at said receiver and contain information on whether at least one transmission link within a data network between said sender and receiver undergoes bad transmission conditions.

It is further proposed a sender for a system for transferring data segments between a sender and a receiver, comprising: means arranged for sending one or more data segments from said sender to said receiver, and means arranged for receiving one or more acknowledgements from said receiver, wherein said acknowledgements acknowledge reception of said sent data segments at said receiver and contain information on whether at least one transmission link within a data network between said sender and receiver undergoes bad transmission conditions.

The sender according to an embodiment of the present invention further comprises means arranged for starting timers associated with each of said sent data segments, respectively, and means arranged for deciding if it is possible to prolong at least one of said timers that has expired before an acknowledgement of a data segment associated with said timer is received, wherein said decision at least partially depends on information whether at least one transmission link within a data network between said sender and receiver undergoes bad transmission conditions.

The sender according to a further embodiment of the present invention further comprises means arranged for prolonging said expired timer if it is decided that prolonging of said expired timer is possible, and means arranged for reducing the size of a congestion window, which at least partially determines the number of data segments said sender is allowed to send, if it is decided that prolonging of said expired timer is not possible.

According to the sender of a further embodiment of the present invention, said sender is a mobile phone or a part thereof.

It is further proposed a software application executable in a sender of a system for transferring data segments, the software application comprising: program code for causing said sender to send one or more data segments from said sender to said receiver, and program code for causing said sender to receive one or more acknowledgements from said receiver, wherein said acknowledgements acknowledge reception of said sent data segments at said receiver and contain information on whether at least one transmission link within a data network between said sender and receiver undergoes bad transmission conditions.

Said software application may also be a computer program product, comprising program code that is stored on a medium, as for instance a memory of said sender.

It is further proposed a receiver for a system for transferring data segments between a sender and a receiver, comprising means arranged for receiving one or more data segments sent from said sender to said receiver, and means arranged for sending one or more acknowledgements to said sender, wherein said acknowledgements acknowledge reception of said sent data segments at said receiver and contain information on whether at least one transmission link within a data network between said sender and receiver undergoes bad transmission conditions.

The receiver according to an embodiment of the present invention further comprises means arranged for receiving a bad transmission link message from a link monitor that indicates that at least one transmission link within said data network undergoes bad transmission conditions.

The receiver according to a further embodiment of the present invention further comprises means arranged for receiving a packet loss message from a link monitor, wherein said packet loss message indicates that at least one data packet was lost on said at least one transmission link.

According to the receiver of a further embodiment of the present invention, said receiver is a mobile phone or a part thereof.

It is further proposed a software application executable in a receiver of a system for transferring data segments, the software application comprising program code for causing said receiver to receive one or more data segments sent from said sender to said receiver, and program code for causing said receiver to send one or more acknowledgements to said sender, wherein said acknowledgements acknowledge reception of said sent data segments at said receiver and contain information on whether at least one transmission link within a data network between said sender and receiver undergoes bad transmission conditions.

Said software application may also be a computer program product, comprising program code that is stored on a medium, as for instance a memory of said receiver.

It is further proposed a device for a system for transferring one or more data segments over a network from a sender to a receiver, said device comprising means arranged for detecting that at least one transmission link within said data network undergoes bad transmission conditions, and means for signalling an indication that said transmission link within said data network undergoes bad transmission conditions to at least one of said sender and said receiver. Said device may for instance be a link monitor.

The device according to an embodiment of the present invention may further comprise means arranged for detecting a packet loss on said at least one transmission link, and means for signalling an indication of said packet loss to at least one of said sender and receiver.

According to the device of a further embodiment of the present invention, said device is a mobile phone or a part thereof.

It is further proposed a software application in a device deployed in a system for transferring one or more data segments over a network from a sender to a receiver, said software application comprising program code for causing said device to detect that at least one transmission link within said data network undergoes bad transmission conditions, and program code for causing said device to signal an indication that said transmission link within said data network undergoes bad transmission conditions to at least one of said sender and said receiver.

Said software application may also be a computer program product, comprising program code that is stored on a medium, as for instance a memory of said device.

These and other aspects of the invention will be apparent from and elucidated with reference to the embodiments described hereinafter.

### BRIEF DESCRIPTION OF THE DRAWING

In the figures show:

FIG. 1: A schematic presentation of a network with a wireless transmission link between a TCP sender and a TCP receiver according to an embodiment of the present invention;

FIG. 2: a schematic presentation of the protocol stacks at the TCP sender and TCP receiver and the signalling of an indication of a bad transmission link according to an embodiment of the present invention;

FIG. 3: a flowchart of the method steps performed at the TCP receiver according to an embodiment of the present invention;

FIG. 4a: a first flowchart of the method steps performed at the TCP sender according to an embodiment of the present invention,

FIG. 4b: a second flowchart of the method steps performed at the TCP sender according to an embodiment of the present invention,

FIG. 4c: a third flowchart of the method steps performed at the TCP sender according to an embodiment of the present invention, and

FIG. 5: a schematic representation of the structure of a TCP segment according to the prior art.

### DETAILED DESCRIPTION OF THE INVENTION

As an initial remark, it should be noted that the subject-matter of the introductory part of this patent application may be used to support this detailed description.

The present invention relates to a method for transferring data segments between a sender and a receiver, wherein one or more data segments are sent from said sender to said receiver, wherein one or more acknowledgements are sent from said receiver to said sender and received at said sender, and wherein said acknowledgements acknowledge reception of said sent data segments at said receiver and contain information on whether at least one transmission link within a data network between said sender and receiver undergoes bad transmission conditions. Said information then may be exploited by said sender to adapt the process of sending data segments to the state of the data network. In this detailed description of the invention, exemplarily frequent reference will be made to a system that is operated according to the Transport Control Protocol (TCP). It is however to be noted that the present invention can equally well be deployed in system that are operated by other protocols.

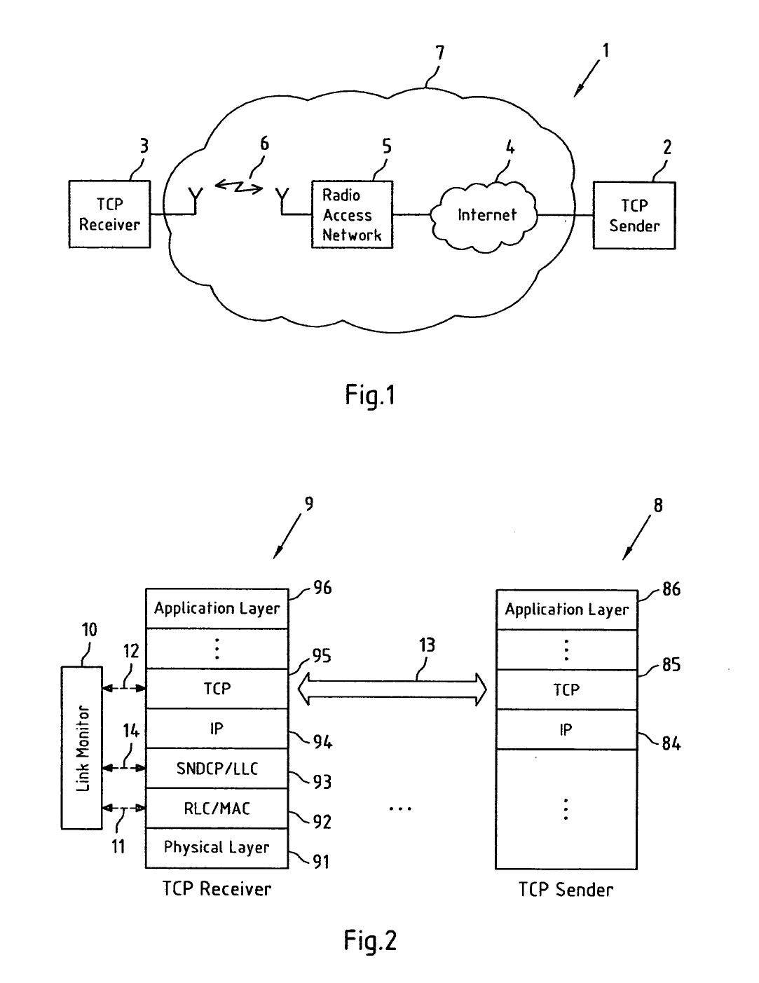

FIG. 1 schematically depicts a system 1 according to an embodiment of the present invention, wherein a network 7 extends between a TCP sender 2 and a TCP receiver 3. The network 7 is composed of an internet 4, a radio access network 5 and a wireless transmission link 6 that allows said TCP receiver 3, which is for instance implemented within a mobile terminal, to exchange data with said radio access network 5. Said radio access network 5, wireless transmission link 6 and mobile terminal then may for instance represent a mobile radio communications system, like the Global System for Mobile Communications (GSM) or the Universal Mobile Telecommunications System (UMTS). Said radio access network 5 is connected with said internet 4, so that said TCP receiver 3 in said mobile terminal is enabled to exchange TCP segments with said TCP sender 2 partially over said internet 4 and said mobile radio communications system. For instance, said TCP sender may be implemented in an internet server providing content that is downloaded by said TCP receiver 3.

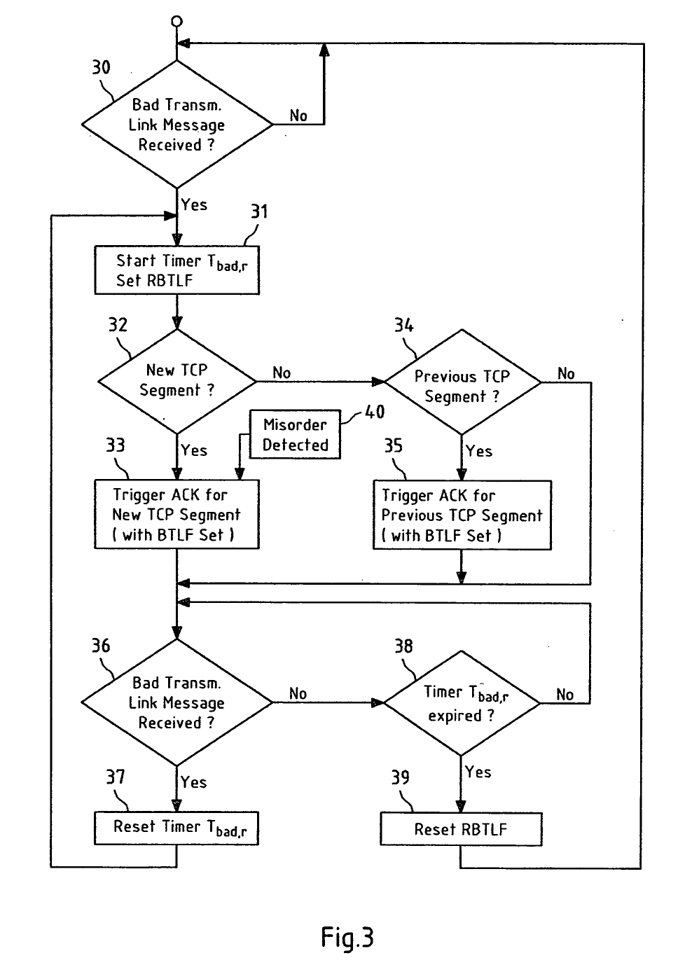

FIG. 2 schematically depicts the protocol stack 8 of the TCP sender 2 and the protocol stack 9 of the TCP receiver 3. In FIG. 2, it is assumed that both protocol stacks have identical application layers 86 and 96, identical transport layers 85 and 95, and identical network layers 84 and 94. Thus TCP segments can be exchanged between peer TCP entities in the TCP receiver 3 and TCP sender 2, as is indicated by arrow 13. The actual transfer of these TCP segments is performed by lower layers of the protocol stack, which, in case of the TCP receiver protocol stack and for the Enhanced General Packet Radio Service (EGPRS), are controlled by the Sub-Network Dependent Convergence (SNDCP) and Logical Link Control (LLC) protocol 93, the Radio Link Control (RLC) and Medium Access Control (MAC) protocol 92, and the physical layer protocol 91. Depending on the types of sub-networks comprised in said network 7 in FIG. 1, a variety of different protocols may be used below the network layer 84 and 94. For instance, the protocols 91, 92 and 93 of the protocol stack 9 of the TCP receiver 3 may be adapted to the lower-layer protocols of a Base Station Subsystem, which in turn may be adapted to the lower-layer protocols of a Serving GPRS Support Node (SGSN), which in turn may be adapted to the lower-layer protocols of a Gateway GPRS Support Node (GGSN), and finally to the lower-layer protocol stack of the internet 4 of the network 7 in FIG. 1. This adaptation is performed in relays, routers and bridges. For simplicity of presentation, this adaptation of the lower-layer protocol is not depicted in FIG. 2, and it is left open which lower-layer protocols are utilized by the protocol stack 8 of TCP sender 2.

In FIG. 2, furthermore a link monitor instance 10 is depicted, which is in interaction with the RLC/MAC protocols of the TCP receiver protocol stack 9, as indicated by arrow 11. According to an embodiment of the present invention, this link monitor instance 10 monitors the wireless transmission link 6 at the RLC/MAC protocol layer either on the side of the mobile terminal or the radio access network 5 and determines, for instance based on connection parameters for different applications in the mobile terminal, if said wireless transmission link 6 has to be assessed as a bad transmission link 6 or not. Criteria for this determination may for instance be a delay or an average delay of data packets on said wireless transmission link. If it is determined by said link monitor 10 that a bad transmission link is presented, the link monitor 10 signals this information to the entities in the TCP layer 95 of the TCP receiver 3 (FIG. 1) via a bad transmission link message, as depicted by arrow 12.

In another embodiment of the present invention, the communication between the RLC/MAC protocols and the entities in the TCP layer 95 of the TCP receiver can be achieved by communication between the RLC/MAC 92 and SNDCP/LLC layer 93, and then the SNDCP/LLC protocol layer 93 can communicate the information to the entities of the TCP layer 95 of the receiver via the link monitor 10, as indicated by arrows 14 and 12.

In yet another embodiment of the present invention, the SNDCP/LLC layer 93 can trigger a signalling of a bad transmission link message from the link monitor 10 to the entities in the TCP layer 95 of the TCP receiver itself just by monitoring the size of the data queue in the SNDCP/LLC protocol layer 93 and communicating with link monitor 10, as indicated by arrow 14.

Arrows 12 and 14 are depicted as bi-directional arrows to indicate that parameters used by said link monitor 10, for instance criteria for bad link reporting, may be set by individual applications as well, so that accessing said link monitor from said SNDCP/LLC layer 93 (arrow 14) and/or TCP layer 95 (arrow 12) may be required.

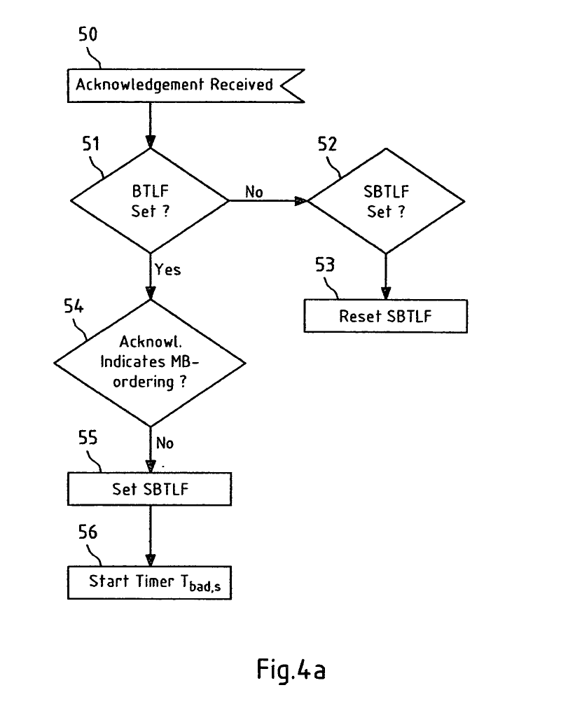

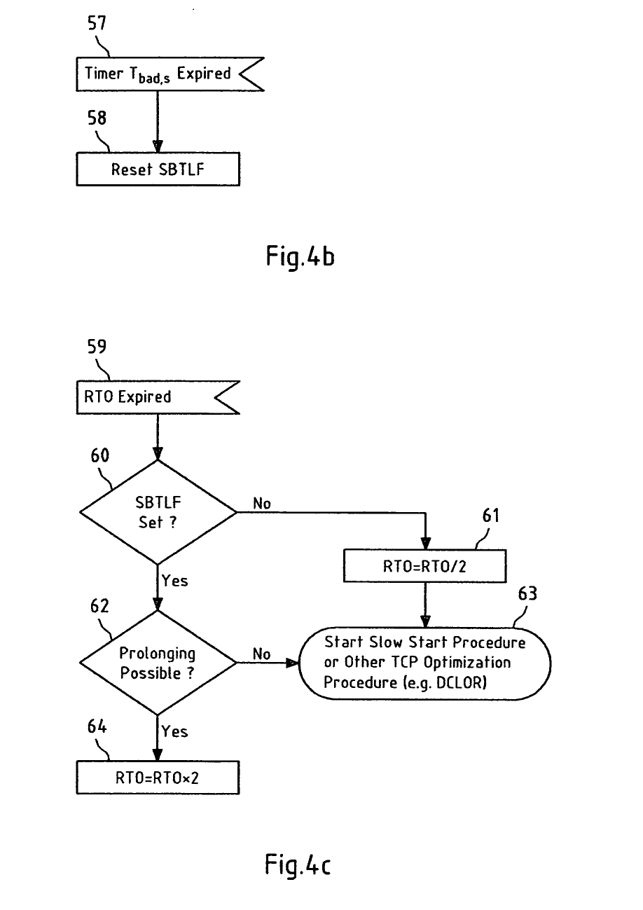

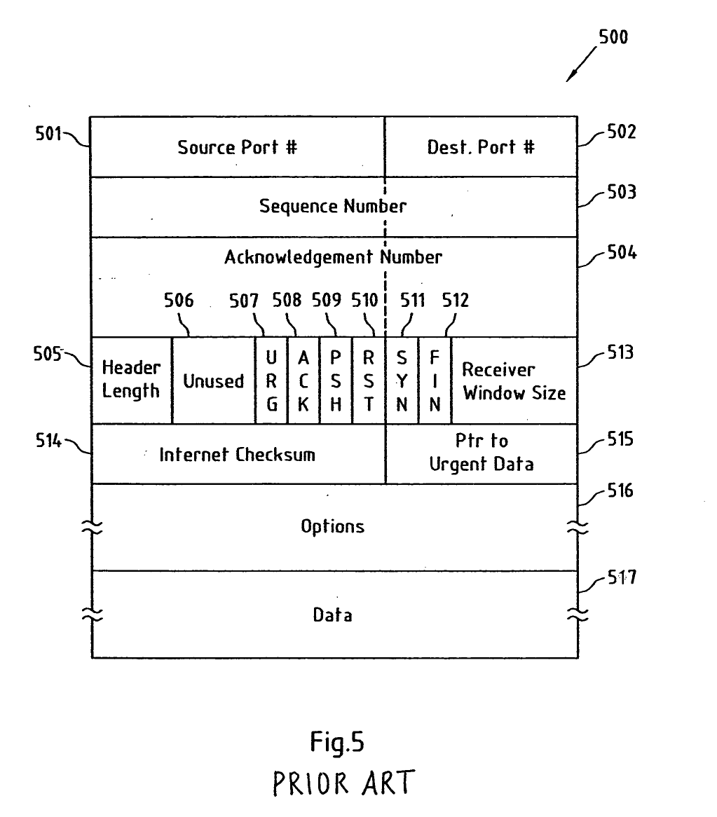

In response to the reception of a bad transmission link message sent by said link monitor 10 (via arrow 12), in TCP receiver 3 (FIG. 1), then a Receiver Bad Transmission Link Flag (RBTLF) is set to indicate that the present TCP connection is based on a bad transmission link. By setting a Bad Transmission Link Flag (BTLF) in the header of TCP acknowledgements that are transmitted from said TCP receiver 3 (FIG. 1) to said TCP sender 2 (FIG. 1), then said sender is informed on said bad transmission link, and may now choose to prolong expired timers for not-yet acknowledged TCP segments to account for this bad transmission link. The BTLF may for instance be one of the unused flags 506 in the TCP header of the TCP segment 500 according to FIG. 5. An exemplary implementation of this procedure will now be explained with reference to FIGS. 3 and 4.

FIG. 3 is a flowchart of the method steps performed at TCP receiver 3 according to an embodiment of the present invention. Therein, only the steps related to the setting and resetting of the RBTLF and the immediate reaction of the TCP receiver 3 to bad transmission link messages received from the link monitor 10 are focussed upon. Further steps performed by said TCP receiver 3, for instance reception of TCP segments and transmission and re-transmission of TCP acknowledgements that are not triggered by the reception of bad transmission link messages from the link monitor are out of the scope of FIG. 3. However, it should be noted that, as soon as the RBTLF is set, all acknowledgements sent by the TCP receiver 3 have a BTLF in the TCP header set, and as soon as the RBTLF is reset, all acknowledgements sent by the TCP receiver 3 have said BTLF in the TCP header reset. It should also be noted that, for the start of the flowchart of FIG. 3, it is assumed that the TCP receiver 3 is not waiting for the reception of a mis-ordered TCP segment.

Turning now to FIG. 3, if a bad transmission link message is received by said TCP receiver 3 from said link monitor 10, see step 30, a timer T_{bad,r} is started, and the RBTLF is set in a step 31. Otherwise, the TCP receiver keeps waiting for such a bad transmission link message to arrive. In a step 32, it is then checked if the TCP receiver 3 was about to send a TCP acknowledgement to acknowledge the reception of a new TCP segment. If this is the case, this TCP acknowledgement is sent with the BTLF in its header set in a step 33. This step 33 is also performed if a mis-ordering of TCP segments is detected at said receiver 3, as is indicated by the event box 40. Otherwise, if there is no new TCP segment that can be acknowledged, it is checked if there was a previous TCP segment the acknowledgement of which could be re-sent in a step 34. If this is the case, this TCP acknowledgement is re-sent with the BTLF in its header set in a step 35. Otherwise, if neither an acknowledgement of a new TCP segment nor a re-acknowledgement of a previous TCP segment is possible, no action is performed.

In a step 36, it is then checked if a further bad transmission link message from link monitor 10 is received. If this is the case, the timer T_{bad,r} is reset to its original value in a step 37, and the method jumps back to step 31. If this is not the case, it is checked whether the timer T_{bad,r} has expired in a step 38. If this is not the case, the method jumps back to step 36. Otherwise, the RBTLF is reset in a step 39. After the resetting of the RBTLF, the method then jumps back to step 30.

In summary, when the TCP receiver receives a bad transmission link message from the link monitor, it starts timer T_{bad,r}, sets the RBTLF, and tries to inform the TCP sender 2 as quickly as possible on the bad transmission link via acknowledgements of new or previous TCP segments. Further bad transmission link messages from link monitor 10 maintain this state. If the timer T_{bad,r} expires without further bad transmission link messages, the bad transmission link is determined to be no longer existent, and the RBTLF is reset.

A possible value for T_{bad,r} could for instance be the RTO of the connection as monitored at the receiver.

FIGS. 4a-4c depict flowcharts of the method steps performed at TCP sender 2 according to an embodiment of the present invention. Therein, only the steps related to the decision if the slow start procedure should be initiated due to an expired RTO timer or if this initiation should be delayed by prolonging said expired RTO timer are focussed upon, and further method steps performed at said TCP sender 2 (FIG. 1) to receive TCP acknowledgements and to sent and re-send TCP segments are not discussed in detail.

If an acknowledgement is received at the TCP sender 2 in a first step 50 according to FIG. 4a, it is checked in step 51 if a BTLF in the header of such an acknowledgement is set. If this is not the case, it is checked in a step 52 if a Sender Bad Transmission Link Flag (SBTLF) is already set. If this is the case, this SBTLF is reset in a step 53.

If a BTLF was set in said acknowledgement, it is checked in a step 54, if said acknowledgement with said BTLF set indicates mis-ordered data segments at said TCP receiver 3. Only if this is not the case, an SBTLF is set in a step 55, and a timer T_{bad,s} is set in a step 56, wherein said timer may for instance be set to the RTO of the TCP connection. If said received acknowledgement with said BTLF set does however indicate mis-ordered data segments at said receiver 3, said acknowledgement is counted as a part of three duplicate acknowledgements, wherein three of said duplicate acknowledgements trigger the a Fast Re-Transmit procedure. If said checking in step 51 comes to a negative result, the acknowledgement is not counted as part of said three duplicate acknowledgements. In particular, if the first TCP acknowledgement received by the TCP sender 2 in step 50 is a re-transmitted acknowledgement with BTLF set (see step 35 of the flowchart of FIG. 3), it is treated as a message to indicate a bad transmission link rather than a duplicate acknowledgement, and TCP will not initiate the standard procedures that are performed when a duplicate acknowledgement is received.

According to FIG. 4b, if at said TCP sender 2, said timer T_{bad,s} expires in an event 57, the SBTLF is immediately reset in a step 58.

FIG. 4c depicts the steps performed at the TCP sender 2 when an RTO timer, which supervises the duration it takes from the sending instant of TCP segment until the reception of an according acknowledgement, expires in an event 59. It is then checked whether the SBTLF at said TCP sender 2 is set in a step 60. If this is the case, according to the present invention, it is checked in a step 62 if prolonging of this expired RTO timer is possible, for instance by assessing if, after a virtual prolonging, said prolonged expired RTO timer would still be smaller than a maximum value for said RTO timer. If this is the case, the prolonging is performed in step 64, in the present example by multiplying the actual value of the RTO timer by the factor two. If it is decided in step 62 that a prolonging of said expired RTO timer is not or no longer possible, the TCP slow start procedure or another TCP optimization procedure (eg. DCLOR) is initiated in a step 63. If it is determined in step 60 that the SBTLF is not set (this state occurs when the RTO timers can not be further prolonged or the timer T_{bad,s} has expired, see step 57 of the flowchart of FIG. 4b), the RTO timer is decreased again in a step 61, for instance by halving its current value, and the TCP slow start or another TCP optimization procedure (e.g. DCLOR) is started in a step 63. The RTO timer may however not be decreased below a pre-defined or default value.

In summary, the TCP sender 2 thus checks acknowledgements received from TCP receiver 3 for a set BTLF, and if a set BTLF is found, a timer T_{bad,s} is started and a state is entered in which prolonging of expired RTO timers is possible, depending on a maximum value for said RTO timers. If this maximum value would be exceeded by a prolonging or a further prolonging, the TCP slow start or other TCP optimization procedures (eg. DCLOR) can be invoked. Also, any acknowledgement received from said TCP receiver 3 with a BTLF reset or an expiration of said timer T_{bad,s} alter said state of said TCP sender to a state where prolonging of expired RTO timers is not possible at all.

A possible value for the maximum value RTO_{Max} of the RTO timer could be

$${RTO}_{Max} = \frac{{L}_{Buffer}}{BW} ,$$

wherein L_{Buffer} denotes the size of the buffer in the radio access network 5 for the mobile terminal that implements said TCP receiver 3 in FIG. 1, and wherein BW is the bandwidth of the wireless transmission link 6 in FIG. 1. The buffer size L_{Buffer} for each mobile terminal may for instance be assumed to be a fixed value, and the BW on the wireless transmission link 6 may be computed based on the mobile terminal's Timeslot Capability (TC), i.e. the number of timeslots a mobile terminal is able to support at a time, on the highest reliable coding scheme that can be used to send data on the wireless transmission link 6, and on the average error rate on the wireless transmission link 6. For instance, in the case of an EGPRS mobile terminal with timeslot capability equalling one, the bandwidth can be expressed as

$$BW = \frac{TC \times CS2}{1 - e} ,$$

wherein CS2 is the data rate when using the EGPRS CS2 coding scheme and wherein e is the block error rate on the wireless transmission link 6.

Thus the present invention prevents TCP applications from having lower throughput due to bad transmission link conditions, which could be interpreted as congestion by the TCP sender, and furthermore prevents unnecessary retransmission of data segments, which increases the efficiency on the air interface.

As performance degradation may occur if TCP segment losses actually occur and are not only assumed due to longer transmission times, it may be advantageous to signal packet losses on the wireless transmission link to the TCP layer, for instance by means of the link monitor 10, and to prevent the prolonging of expired RTO timers in that case. This can for instance be achieved by resetting the RBTLF (cf. step 39 in FIG. 3) in response to a signal from the link monitor that a packet loss occurred. Alternatively, packet loss may also be signalled from the TCP receiver 3 to the TCP sender 2 via acknowledgements, and said information on said packet loss on said wireless transmission link then may inhibit the prolonging of expired RTO timers in step 64 of FIG. 4c. Thus in case of actual TCP segment loss, the prior art approach of congestion control would be pursued again. Even if the algorithm is aggressive, i.e. uses large maximum values for the RTO timers, there may then be no performance degradation as compared to the prior art approach in case of actual TCP segment loss.

The invention has been described above by means of various embodiments. It should be noted that there are alternative ways and other variations which in light of the teachings hereof would be evident to a skilled person in the art and can be implemented without deviating from the scope and spirit of the appended claims. In particular, the present invention is not limited to the TCP or the EGRPS system, it may equally well be deployed in the context of systems that transfer data packets using different protocols. Furthermore, the proposed methods are also suited to be used on top of existing optimizations of TCP as for instance the “De-correlated Loss Recovery using SACK option for spurious timeouts” (DCLOR) or Eiffel.

1. A method for transferring data segments between a sender and a receiver, comprising:
sending one or more data segments from said sender to said receiver, and
receiving one or more acknowledgements from said receiver, wherein said acknowledgements acknowledge reception of said sent data segments at said receiver and contain information on whether at least one transmission link within a data network between said sender and receiver undergoes bad transmission conditions.

2. The method according to claim 1, further comprising:
starting timers associated with each of said sent data segments, respectively; and
deciding if it is possible to prolong at least one of said timers that has expired before an acknowledgement of a data segment associated with said timer is received, wherein said decision at least partially depends on information whether at least one transmission link within a data network between said sender and receiver undergoes bad transmission conditions.

3. The method according to claim 2, wherein it is only possible to prolong said expired timer if
a first condition, that at least one transmission link within a data network between said sender and said receiver undergoes bad transmission conditions, and
a second condition, that said expired timer, after prolonging, will not exceed a maximum value for said timer, are both true.

4. The method according to claim 2, further comprising:
prolonging said expired timer if it is decided that prolonging of said expired timer is possible; and
reducing the size of a congestion window, which at least partially determines the number of data segments said sender is allowed to send, if it is decided that prolonging of said expired timer is not possible.

5. The method according to claim 1, wherein said transmission link is a wireless link.

6. The method according to claim 4, wherein said expired timer is prolonged by doubling its value.

7. The method according to claim 3, wherein said maximum value for said timer depends on the quotient of an expected bandwidth of said transmission link and a size of a buffer at one end of said transmission link.

8. The method according to claim 7, wherein said transmission link is a wireless link between a mobile terminal and a node of said network, wherein said buffer is a buffer in said node, and wherein said buffer is related to said mobile terminal.

9. The method according to claim 8, wherein said bandwidth depends on a timeslot capability of said mobile terminal, a highest reliable coding scheme that can be used on said transmission link and an average error rate on said transmission link.

10. The method according to claim 9, wherein said bandwidth, BW, is determined as:
$$BW = \frac{TC \times r}{1 - e} ,$$
wherein TC is said timeslot capability of said mobile terminal, r is a data rate of said highest reliable coding scheme and e is an average block error rate on said transmission link.

11. The method according to claim 1, wherein said information on whether at least one transmission link within said data network between said sender and receiver undergoes bad transmission conditions is represented by a Bad Transmission Link Flag, BTLF, in said acknowledgements.

12. The method according to claim 11, wherein said sender, upon receiving an acknowledgement from said receiver, performs the following:
if said acknowledgement has a BTLF set and if said acknowledgement does not indicate a mis-ordering of data segments at said receiver, setting a Sender Bad Transmission Link Flag, SBTLF and starting a timer T_{bad,s}; and
if said acknowledgement has a BTLF reset and if said SBTLF is not set, resetting said SBTLF.

13. The method according to claim 12, wherein said sender, when said timer T_{bad,s} expires, performs the following:
resetting said SBTLF.

14. The method according to claim 12, wherein said sender, when one of said timers expires, performs the following:
prolonging said expired timer, if said SBTLF is set and if said expired timer, after prolonging, will not exceed said maximum value for said timer;
reducing the size of said congestion window, if said SBTLF is set and if said expired timer, after prolonging, will exceed said maximum value for said timer; and
shortening said expired timer and reducing the size of said congestion window, if said SBTLF is not set.

15. The method according to claim 4, wherein said expired timer is not prolonged if it is indicated to at least one of said sender and said receiver that at least one data packet was lost on said transmission link.

16. The method according to claim 1, wherein said transferring of data segments between said sender and said receiver is controlled by the Transport Control Protocol.

17. The method according to claim 4, wherein said transferring of data segments between said sender and said receiver is controlled by the Transport Control Protocol, and wherein with said reducing of said size of said congestion window, a slow start procedure is started.

18. The method according to claim 2, wherein said transferring of data segments between said sender and said receiver is controlled by the Transport Control Protocol, and wherein said expired timer is a Retransmission Time-Out, RTO, timer.

19. The method according to claim 11, wherein said transferring of data segments between said sender and said receiver is controlled by the Transport Control Protocol, TCP, wherein said acknowledgements are TCP acknowledgements, and wherein at least one bit in said TCP acknowledgements is used to set and reset said bad transmission link flag.

20. A method for transferring data segments between a sender and a receiver, comprising:
receiving one or more data segments sent from said sender to said receiver, and
sending one or more acknowledgements to said sender, wherein said acknowledgements acknowledge reception of said sent data segments at said receiver and contain information on whether at least one transmission link within a data network between said sender and receiver undergoes bad transmission conditions.

21. The method according to claim 20, further comprising:
receiving a bad transmission link message from a link monitor that indicates that at least one transmission link within said data network undergoes bad transmission conditions.

22. The method according to claim 20, wherein said information on whether at least one transmission link within said data network between said sender and receiver undergoes bad transmission conditions is represented by a Bad Transmission Link Flag, BTLF, in said acknowledgements.

23. The method according to claim 22, wherein said receiver maintains a Receiver Bad Transmission Link Flag, RBTLF, determining if acknowledgements are sent with said BTLF set or reset, and wherein said receiver, upon receiving said bad transmission link message, performs the following:
starting a timer T_{bad,r} and setting said RBTLF;
sending an acknowledgement of a newly received data segment with said BTLF set, if acknowledgement of said newly received data segment is possible;
sending an acknowledgement of a previously received data segment with said BTLF set, if acknowledgement of a newly received data segment is not possible, but acknowledgement of said previously received data segment is possible;
if a further bad transmission link message is received from said link monitor before the expiry of said timer T_{bad,r},
a) starting said timer T_{bad,r} again,
b) sending an acknowledgement of a newly received data segment with said BTLF set, if acknowledgement of said newly received data segment is possible, and
c) sending an acknowledgement of a previously received data segment with said BTLF set, if acknowledgement of a newly received data segment is not possible, but acknowledgement of said previously received data segment is possible; and
resetting said RBTLF, if no further bad transmission link message is received from said link monitor before the expiry of said timer T_{bad,r}.

24. The method according to claim 23, wherein a value of said timer T_{bad} equals a value of a timer monitored at said receiver.

25. A system for transferring data segments, comprising:
a sender, and
a receiver;
wherein said sender comprises means arranged for sending one or more data segments from said sender to said receiver and means arranged for receiving one or more acknowledgements from said receiver, wherein said receiver comprises means arranged for receiving said sent data segments, and means arranged for sending said acknowledgements, and wherein said acknowledgements acknowledge reception of said sent data segments at said receiver and contain information on whether at least one transmission link within a data network between said sender and receiver undergoes bad transmission conditions.

26. A sender for a system for transferring data segments between a sender and a receiver, comprising:
means arranged for sending one or more data segments from said sender to said receiver, and
means arranged for receiving one or more acknowledgements from said receiver, wherein said acknowledgements acknowledge reception of said sent data segments at said receiver and contain information on whether at least one transmission link within a data network between said sender and receiver undergoes bad transmission conditions.

27. The sender according to claim 26, further comprising:
means arranged for starting timers associated with each of said sent data segments, respectively; and
means arranged for deciding if it is possible to prolong at least one of said timers that has expired before an acknowledgement of a data segment associated with said timer is received, wherein said decision at least partially depends on information whether at least one transmission link within a data network between said sender and receiver undergoes bad transmission conditions.

28. The sender according to claim 27, further comprising:
means arranged for prolonging said expired timer if it is decided that prolonging of said expired timer is possible; and
means arranged for reducing the size of a congestion window, which at least partially determines the number of data segments said sender is allowed to send, if it is decided that prolonging of said expired timer is not possible.

29. The sender according to claim 26, wherein said sender is a mobile phone or a part thereof.

30. A software application executable in a sender of a system for transferring data segments, the software application comprising:
program code for causing said sender to send one or more data segments from said sender to said receiver, and
program code for causing said sender to receive one or more acknowledgements from said receiver, wherein said acknowledgements acknowledge reception of said sent data segments at said receiver and contain information on whether at least one transmission link within a data network between said sender and receiver undergoes bad transmission conditions.

31. A receiver for a system for transferring data segments between a sender and a receiver, comprising:
means arranged for receiving one or more data segments sent from said sender to said receiver; and
means arranged for sending one or more acknowledgements to said sender, wherein said acknowledgements acknowledge reception of said sent data segments at said receiver and contain information on whether at least one transmission link within a data network between said sender and receiver undergoes bad transmission conditions.

32. The receiver according to claim 31, further comprising:
means arranged for receiving a bad transmission link message from a link monitor that indicates that at least one transmission link within said data network undergoes bad transmission conditions.

33. The receiver according to claim 31, further comprising:
means arranged for receiving a packet loss message from a link monitor, wherein said packet loss message indicates that at least one data packet was lost on said at least one transmission link.

34. The receiver according to claim 31, wherein said receiver is a mobile phone or a part thereof.

35. A software application executable in a receiver of a system for transferring data segments, the software application comprising:
program code for causing said receiver to receive one or more data segments sent from said sender to said receiver; and
program code for causing said receiver to send one or more acknowledgements to said sender, wherein said acknowledgements acknowledge reception of said sent data segments at said receiver and contain information on whether at least one transmission link within a data network between said sender and receiver undergoes bad transmission conditions.

36. A device for a system for transferring one or more data segments over a network from a sender to a receiver, said device comprising:
means arranged for detecting that at least one transmission link within said data network undergoes bad transmission conditions, and
means for signalling an indication that said transmission link within said data network undergoes bad transmission conditions to at least one of said sender and said receiver.

37. The device according to claim 36, further comprising:
means arranged for detecting a packet loss on said at least one transmission link, and
means for signalling an indication of said packet loss to at least one of said sender and receiver.

38. The device according to claim 36, wherein said device is a mobile phone or a part thereof.

39. A software application in a device deployed in a system for transferring one or more data segments over a network from a sender to a receiver, said software application comprising:
program code for causing said device to detect that at least one transmission link within said data network undergoes bad transmission conditions, and
program code for causing said device to signal an indication that said transmission link within said data network undergoes bad transmission conditions to at least one of said sender and said receiver.
